(19) United States
(12) Patent Application Publication
(10) Pub. No.: US 2023/0379945 A1
(43) Pub. Date: Nov. 23, 2023

(54) METHOD AND DEVICE FOR RECEIVING MBS SERVICE DATA, AND COMMUNICATION CHIP

(71) Applicant: SPREADTRUM COMMUNICATIONS (SHANGHAI) CO., LTD., Shanghai (CN)

(72) Inventors: Youyou ZHANG, Shanghai (CN); Lifeng HAN, Shanghai (CN)

(21) Appl. No.: 18/352,278

(22) Filed: Jul. 14, 2023

Related U.S. Application Data
(63) Continuation of application No. PCT/CN2022/076424, filed on Feb. 16, 2022.

(30) Foreign Application Priority Data
Jan. 14, 2021 (CN) 202110049407.3

(51) Int. Cl. H04W 72/30; H04W 72/232; H04W 76/20

(52) U.S. Cl. CPC H04W 72/30; H04W 72/232; H04W 76/20

(57) ABSTRACT

Provided are a method and device for receiving MBS service data. The method includes the following steps. A terminal device receives first information sent by a network device, where the first information includes data status information of at least one MBS service. In response to determining, according to the data status information of the at least one MBS service, that service data of a target MBS service is in a transmission state, the terminal device receives the service data of the target MBS service.

### CROSS-REFERENCE TO RELATED APPLICATIONS

This application is a continuation of International Application No. PCT/CN2022/076424, filed on Feb. 16, 2022, which claims priority to Chinese Application No. 202110049407.3, entitled “METHOD AND DEVICE FOR RECEIVING MBS SERVICE DATA”, filed to the China National Intellectual Property Administration on Jan. 14, 2021. Both of the aforementioned applications are hereby incorporated by reference in their entireties.

### TECHNICAL FIELD

The present disclosure relates to the technical field of communications, and in particular, to a method and device for receiving Multi-cast Broadcast Service (MBS) service data, a method and device for sending MBS service data, a communication chip, and a computer-readable storage medium.

### BACKGROUND

Multi-cast Broadcast Service (MBS) refers to transmitting the same data to multiple terminal users (multicast) or all terminal users (broadcast) in a point-to-multipoint manner over an air interface of a wireless network. Based on the MBS technology, network resource sharing is achieved, improving the utilization of network resources, especially the utilization of the air interface resources, such that high-speed and stable multimedia services can be provided to users efficiently. Therefore, research on how to receive data in MBS services is of significant practical value.

### SUMMARY

Embodiments of the present disclosure provide a method and device for receiving MBS service data, a method and device for sending MBS service data, a communication chip, and a computer-readable storage medium. The terminal device obtains data status of MBS service data efficiently and receives the MBS service data according to the data status of the MBS service data.

According to one aspect of the present disclosure, a method for receiving MBS service data is provided. The method includes: receiving first information sent by a network device, where the first information includes data status information of at least one MBS service; and determining, according to the data status information of the at least one MBS service, whether to receive service data of the MBS service.

According to another aspect of the present disclosure, method for sending MBS service data is provided. The method includes: sending first information to a terminal device, where the first information includes data status information of at least one MBS service; and in response to a determination that some or all MBS services of the at least one MBS service are in a transmission state, sending service data of the some or all MBS services to the terminal device.

According to another aspect of the present disclosure, a terminal device is provided. The terminal device includes: at least one processor, and at least one memory in communication connection with the processor. The at least one memory stores program instructions executable by the at least one processor, and the at least one processor executes the program instructions to execute the method for receiving MBS service data.

According to another aspect of the present disclosure, a network device is provided. The network device includes: at least one processor and at least one memory in communication connection with the processor. The at least one memory stores program instructions executable by the at least one processor, and the at least one processor executes the program instructions to execute the method for sending MBS service data.

According to another aspect of the present disclosure, a communication chip is provided. The communication chip includes at least one processor configured to execute computer program instructions stored in a memory. When the computer program instructions are executed by the at least one processor, the communication chip is caused to perform the method for receiving MBS service data.

According to another aspect of the present disclosure, a non-transitory computer-readable storage medium is provided. The computer-readable storage medium stores a computer program. When being executed, the program causes a device where the computer-readable storage medium is located to implement the method for receiving MBS service data.

According to another aspect of the present disclosure, a non-transitory computer-readable storage medium is provided. The computer-readable storage medium stores a computer program. When being executed, the program causes a device where the computer-readable storage medium is located to implement the method for sending MBS service data.

### BRIEF DESCRIPTION OF DRAWINGS

To describe the technical solutions of the embodiments of this application more clearly, the following briefly describes the accompanying drawings required in the embodiments. Apparently, the accompanying drawings in the following description show merely some examples of this application, and a person of ordinary skill in the art can still derive other drawings from these accompanying drawings without creative efforts.

FIG. 1 is a schematic diagram of a scenario of a communication system according to an embodiment of the present disclosure;

FIG. 2-a is a flowchart of a method for receiving MBS service data according to an embodiment of the present disclosure;

FIG. 2-b is a schematic diagram of an MBS service field according to an embodiment of the present disclosure;

FIG. 2-c is a schematic diagram of a status bitmap according to an embodiment of the present disclosure;

FIG. 3 is a flowchart of a method for sending MBS service data according to an embodiment of the present disclosure;

FIG. 4 is a schematic structural diagram of a terminal device according to an embodiment of the present disclosure; and

FIG. 5 is a schematic structural diagram of a network device according to an embodiment of the present disclosure.

### DESCRIPTION OF EMBODIMENTS

For a better understanding of the technical solutions of this application, embodiments of the present disclosure are described in detail below with reference to the accompanying drawings.

It should be noted that, the described embodiments are merely some but not all of the embodiments of this disclosure. All other embodiments obtained by a person of ordinary skill in the art based on the embodiments of this disclosure without creative efforts shall fall within the protection scope of this disclosure.

Terms in the embodiments of the present disclosure are merely used to describe the specific embodiments, and are not intended to limit the present disclosure. Unless otherwise specified in the context, words, such as “a”, “the”, and “said”, in a singular form in the embodiments and appended claims of the present disclosure include plural forms.

In the embodiments of the present disclosure, in response to a determination that the MBS service has no MBS service data to be received, the terminal device will be released to an INACTIVE/IDLE state. When the terminal device needs to receive MBS service data, the terminal device is switched to a connected state and continues to receive the MBS service data. Accordingly, in the MBS service, the terminal device needs to switch the connection status based on the data status of the MBS service data. Therefore, how to notify the terminal device of the data status of the MBS service data in a reasonable and effective manner is a problem that needs to be solved.

FIG. 1 is a schematic diagram of a scenario of a communication system according to an embodiment of the present disclosure. As shown in FIG. 1, the communication system 100 may include at least one network device 101 and at least one terminal device 102. The connection between the network device 101 and the terminal device 102, the connection between the terminal devices 102, and the connection between the network devices 101 are implemented through a wired or wireless communication technology. It should be noted that the number and configuration of the terminal devices 102 and the network devices 101 shown in FIG. 1 are not limited in the embodiments of the present disclosure. In different embodiments, the network device 101 may further be connected to a core network device, which is not shown in FIG. 1.

It should be noted that the wireless communication system in embodiments of the present disclosure includes, but is not limited to: Narrow Band-Internet of Things (NB-IoT), Global System for Mobile Communications (GSM) 100, Enhanced Data Rate for GSM Evolution (EDGE), Wideband Code Division Multiple Access (WCDMA), Code Division Multiple Access 2000 (CDMA2000), Time Division-Synchronous Code Division Multiple Access (TD-SCDMA), Long Term Evolution (LTE), the fifth generation mobile communication system or possible sixth or seventh generation mobile communication system, a vehicle-mounted wireless short-range communication system, and future mobile communication systems.

In the embodiments of the present disclosure, the network device 101 is an apparatus that is deployed in a wireless access network and provides wireless communication functionality to the terminal device 102. The network device 101 may include, but is not limited to, a base station (BS), a station (STA) which includes an access point (AP) and a non-AP station, a network controller, a transmission and reception point (TRP), a mobile switching center, or a wireless access point in a WiFi network. For example, an apparatus that directly communicates with the terminal device 102 through a wireless channel is typically a base station. The base station may include a macro base station, a micro base station, a relay station, an access point, a remote radio unit (RRU) in various forms, or the like. Certainly, other network devices 101 with wireless communication capabilities can also communicate in a wireless manner with the terminal device 102. The present disclosure does not limit the network device to a specific device.

The terminal device 102 may include, for example, user equipment (UE), a mobile station (MS), a mobile terminal (MT), or the like, and is a device that provides voice and/or data communication to users. For example, the terminal device may be a handheld device, a vehicle-mounted device, a wearable device, a computing device, or any other processing device connected to a wireless modem and having a wireless connectivity capability. Currently, some examples of the terminal include: a mobile phone, a tablet commuter, a laptop computer, a palmtop computer, a Mobile Internet Device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, and a wireless terminal in smart home.

It should be noted that in different systems, the device may have different names. For example, in an LTE network, the base station is referred to as an evolved Node B (eNB or eNodeB). In a 3rd Generation (3G) network, the base station is referred to as a Node B, and in a 5G network, the base station is referred to as a 5G base station (NR Node B or gNB).

In a wireless communication system, MBS service data is transmitted from a data network to a core network (not shown in FIG. 1). The core network transmits the MBS service data to a base station using a shared MBS traffic delivery method or an individual MBS traffic delivery method. Finally, the base station transmits the MBS service data to a single terminal device or a group of terminal devices. The terminal device receives the MBS service data and is switched between the inactive/idle state and the connected state according to the data status of the MBS service data.

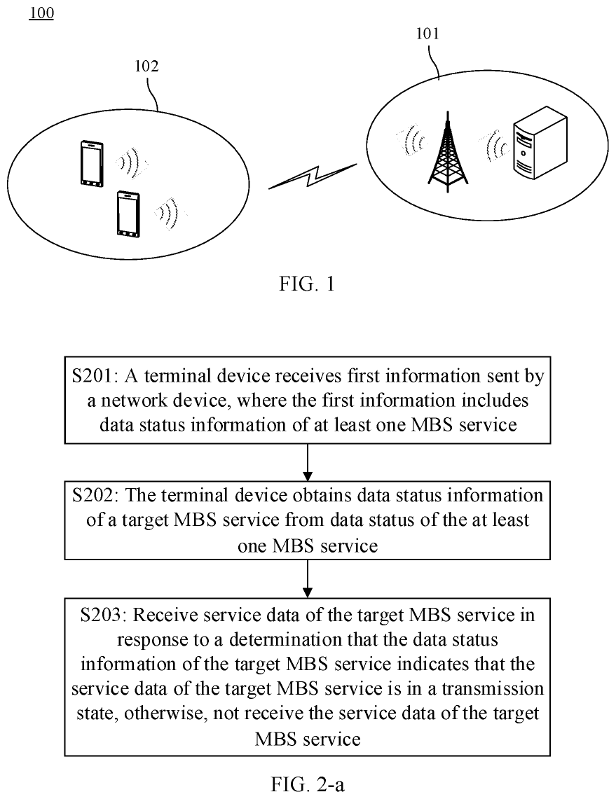

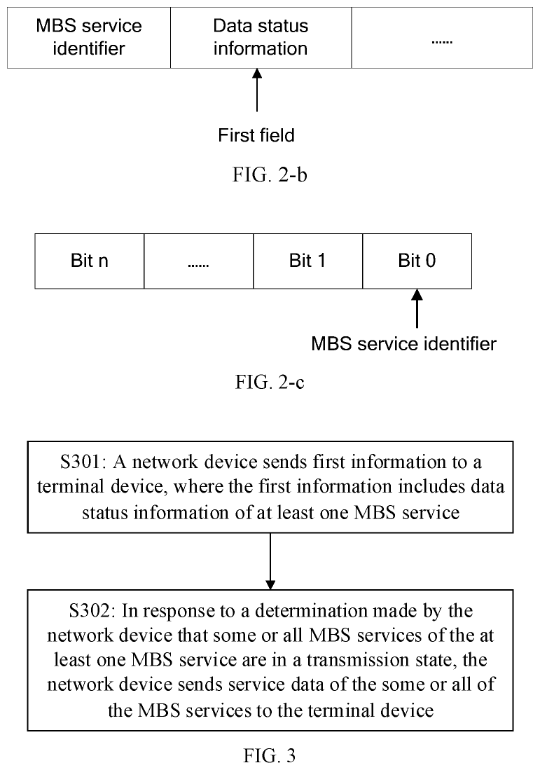

FIG. 2-a is a flowchart of a method for receiving MBS service data according to an embodiment of the present disclosure. The method is executed by the terminal device in the system shown in FIG. 1. As shown in FIG. 2, the method includes the following steps.

In S201, the terminal device receives first information sent by a network device. The first information includes data status information of at least one MBS service. In some embodiments, the data status information of the MBS service indicates whether the MBS service has data to be transmitted. In some embodiments, the data status information of the MBS service may indicate a state of terminating transmission of the MBS service data, a state of transmitting the MBS service data, or other states.

In S202, the terminal device obtains data status information of a target MBS service from data status information of the at least one MBS service. The target MBS service is an MBS service that the terminal device is interested in.

In S203, service data of the target MBS service is received in response to a determination that the data status information of the target MBS service indicates that the service data of the target MBS service is in a transmission state; otherwise, the service data of the target MBS service is not received.

In the MBS scenario, the terminal device can receive the data status information of multiple MBS services sent by the network device. In response to a determination that the multiple MBS services include the target MBS service and the service data of the target MBS service is in a transmission state, the terminal device receives the service data of the target MBS service. In some embodiments, the target MBS service may be one MBS service or a plurality of MBS services.

In some embodiments, when the terminal device determines that the service data of the target MBS service is in a transmission state, the RRC connection is switched from an inactive/idle state to a connected state, and then the terminal device receives the service data of the target MBS service. In some embodiments, if the terminal device determines, according to the received data status information of the MBS services, that transmission of the service data of the target MBS service is terminated, the terminal device is switched from the connected state to the idle/inactive state.

In some embodiments, the RRC connection status of the terminal device when receiving the MBS service is not limited. Therefore, in response to a determination that the service data of the target MBS service is in a transmission state, the terminal device may keep the current state and directly receive the service data of the target MBS service from the network device. In response to a determination that the transmission of the service data of the target MBS service is terminated, the terminal device may stop receiving the service data of the target MBS service without switching to the inactive/idle state. In this way, the sensitivity of the terminal device in receiving the MBS service data is improved

Further, the network device may send the first information to the terminal device in different manners. In some embodiments, the first information may be carried in one or more of the following types of information: MBS control information, system information, DCI, and a short message. The MBS control information may be carried in an MBS control channel or a broadcast channel. The short message may be transmitted using a short message field of DCI format 1_0.

Specifically, the data status information of the MBS service may be implemented by different methods in the first information. As shown in FIG. 2-b, the first information includes a service field of each MBS service. The service field of each MBS service includes a first field, and the first field indicates the data status information of the corresponding MBS service. As shown in FIG. 2-b, the service field of the MBS service may include an MBS service identifier and the first field. In response to a determination that the value of the first field is 1, it indicates that service data of a first MBS service is arriving again or being transmitted, that is, the service data of the first MBS service is in a transmission state. In response to a determination that the value of the first field is 0, it indicates that transmission of the service data of the first MBS service is stopped. It should be noted that the position of the MBS service identifier and the position of the first field in the MBS service field may be set according to actual needs. FIG. 2-b shows an example that the first field is placed after the MBS service identifier. In another example, the first field may be placed at the end of the MBS service field.

In some embodiments, the data status information of the MBS service in the first information may be implemented in the following manner. The first information includes a status bitmap. The bits of the status bitmap may be used to indicate the data status information of the MBS services. As shown in FIG. 2-c, the status bitmap includes n bits, and each MBS service may be mapped to one bit. The value of the bit mapped to the corresponding MBS service may represent the data status information of the corresponding MBS service. For example, as shown in FIG. 2-c, bit 0 is mapped to MBS service 1, and the value of bit 0 represents the data status information of MBS service 1. For example, in response to a determination that the value of bit 0 is 1, it indicates that the service data of MBS service 1 is arriving again or being transmitted, that is, the service data of MBS service 1 is in a transmission state. In response to a determination that the value of bit 0 is 0, the value of the first field is 0, indicating that transmission of the service data of MBS service 1 is terminated. Certainly, bit 0 may be mapped to another MBS service identifier.

In some embodiments, the mapping relationship between the MBS services and the bits of the status bitmap may be referred to as a first mapping relationship. The network device may send second information containing the first mapping relationship to the terminal device. The second information may be carried in one of or a combination of two or more of the following types of information: MBS control information, system information, DCI, and a short message. It should be noted that the first information and the second information can be carried in the same information or carried in different information. In the example that the first information and the second information are carried in different information, the sequence of sending the first information and sending the second information is not limited. In some examples, the status bitmap can be sent to the terminal device through DCI or a short message, while the first mapping relationship can be sent to the terminal device through MBS control information or system information. For example, the status bitmap can be sent to the terminal device through MBS control information, while the first mapping relationship can be sent to the terminal device through system information. For another example, the status bitmap can be sent to the terminal device through system information, while the first mapping relationship can be sent to the terminal device through MBS control information. The above examples only illustrate the possible manners of carrying the status bitmap and the first mapping relationship. Other possible information carrying manners are not enumerated here. The terminal device can locate a target bit corresponding to the target MBS in the status bitmap according to the first mapping relationship, and determine the data status information of the target MBS service according to the value of the target bit. For example, one bit in the status bitmap corresponds to one MBS service. The terminal device locates the target bit using the first mapping relationship. In response to a determination that the value of the target bit is 1, it indicates that the service data of the target MBS service is arriving again or being transmitted, that is, the service data of the target MBS service is in a transmission state. In response to a determination that the value of the target bit is 0, it indicates that transmission of the service data of the target MBS service is ended.

Furthermore, the first mapping relationship may be represented in an explicit manner or represented in an implicit manner. In some embodiments, the first mapping relationship is represented in an explicit manner, the second information includes a correspondence between the MBS services and the bits of the status bitmap. For example, the network device provides three MBS services including MBS service 1, MBS service 2, and MBS service 3. The second information includes bits in the status bitmap corresponding to the three MBS services respectively. For example, the MBS service 1 corresponds to bit 2, MBS service 2 corresponds to bit 0, and MBS service 3 corresponds to bit 1. Examples of the mapping relationship between the MBS services and the bits of the status bitmap are not enumerated herein.

The first mapping relationship is represented in an implicit manner. The second information includes an MBS service list, and positions of the MBS services in the MBS service list correspond to the bits of the status bitmap. In one example, sequence numbers of the MBS services correspond to the bits of the status bitmap. For instance, the sequence numbers of MBS service 1, MBS service 2, and MBS service 3 are 1, 2, and 3 respectively. The sequence numbers 1, 2, and 3 correspond to bits 0, 1, and 2 of the status bitmap respectively, or there may be other possible corresponding manners.

Furthermore, in addition to using the first field and the status bitmap to represent the data status information in the first information, the data status information may be represented using a status recovery index. In some embodiments, the first information includes status recovery indices. Each status recovery index corresponds to one MBS service and is used to indicate that service data of the corresponding MBS service has transitioned to a transmission state. For example, in response to a determination that the data status of a particular MBS service changes, the network device sends the corresponding status recovery index of the particular MBS service to the terminal device. For instance, the status recovery index includes 4 bits and the value is 0010, indicating that the data status of the corresponding MBS service has changed. If the MBS service data is in a transmission state before the index 0010 is received, upon reception of the index 0010, transmission of the MBS service data is stopped. Certainly, if transmission of the MBS service data is already stopped before the index 0010 is received, upon reception of the index 0010, the status of the MBS service data is changed to a transmission state. In some embodiments, upon determining that data of an MBS service is changed to a transmission state, the network device sends the corresponding status recovery index of the MBS service to the terminal device. Upon receiving the status recovery index, the terminal device determines that the service data of the corresponding MBS service is in a transmission state.

In some embodiments, the mapping relationship between MBS services and status recovery indices may be referred to as a second mapping relationship. The network device can send the second information containing the second mapping relationship to the terminal device. The second information may be carried in one of or a combination of two or more of the following types of information: MBS control information, system information, DCI, and a short message. It should be noted that the first information and the second information may be carried in the same information or carried in different information. In response to a determination that the first information and the second information are carried in different information, the sequence of sending the first information and sending the second information is not limited. In some examples, the status recovery index may be sent to the terminal devices through DCI or a short message, while the second mapping relationship may be sent to the terminal devices through MBS control information or system information. For another example, the status recovery index may be sent to the terminal device through MBS control information, while the second mapping relationship may be sent to the terminal device through system information. For another example, the status recovery index may be sent to the terminal device through system information, while the second mapping relationship can be sent to the terminal device through MBS control information. The above examples only illustrate the possible manners of carrying the status recovery index and the second mapping relationship. Other possible information carrying manners are not enumerated here. The terminal device can locate the MBS service corresponding to the received status recovery index according to the second mapping relationship, and determine that transmission of the data of the target MBS service is resumed.

Further, the second mapping relationship may be represented in an explicit manner or implicit manner. In some embodiments, the second mapping relationship is represented in an explicit manner, the second information includes a correspondence between the MBS services and the status recovery indices. For example, the network device provides three MBS services: MBS service 1, MBS service 2, and MBS service 3. The second information includes status recovery indices corresponding to the three MBS services respectively. For instance, MBS service 1 corresponds to status recovery index 1, MBS service 2 corresponds to status recovery index 2, and MB S service 3 corresponds to status recovery index 3. Examples of the mapping relationship between MBS services and status recovery indexes are not enumerated herein.

The second mapping relationship may be represented in an implicit manner. The second information includes an MBS service list, and positions of the MBS services in the MBS service list correspond to the status recovery indices. In an example, sequence numbers of the MBS services correspond to the status recovery indices. For instance, the sequence numbers of MBS service 1, MBS service 2, and MBS service 3 are 1, 2, and 3 respectively. The sequence numbers 1, 2, and 3 correspond to status recovery index 3, status recovery index 2, and status recovery index 1 respectively.

Considering the different manners of carrying and implementing the first information, the transmission process of the data status information will be described in detail below using specific examples.

In embodiment 1, a network device sends MBS control information to a terminal device based on a Multi-Cast Control Channel (MCCH). The MBS control information carries data status information of each MBS service. In some embodiments, the data status information of each MBS service in the MBS control information may be implemented in the following manner. A first field is configured for the MBS service, and the data status information of the MBS service is indicated by the first field. In some embodiments, in the MBS control information, the data status information of the MBS services may be indicated by a status bitmap or status recovery indices.

In the MBS control information, a first field is configured for each MBS service. To indicate the data status information of the MBS service through the first field, a service field is configured in the MBS control information for the MBS service. The service field includes the first field, and the first field is used to represent the data status information of the MBS service. For example, in response to a determination that the value of the first field of the first MBS service is 1, it indicates that the service data of the first MBS service is arriving again or being transmitted, that is, the service data of the first MBS service is in a transmission state. In response to a determination that the value of the first field of the first MBS service is 0, it indicates that transmission of the service data of the first MBS service is stopped.

Indicating the data status information of the MBS service through a status bitmap in the MBS control information is implemented in the following manner. The status bitmap includes a plurality of bits, with each bit being mapped to one MBS service identifier. The value of the bit represents the data status information of the corresponding MBS service. For example, a bit value of 1 indicates that the service data of the corresponding MBS service is in a transmission state, while a bit value of 0 indicates that transmission of the service data of the corresponding MBS service is stopped. Optionally, the mapping relationship between the MBS service identifiers and the bits of the status bitmap can also be sent to the terminal device through MBS control information. Optionally, the mapping relationship may also be sent to the terminal device through other information, such as system information.

In a specific example, it is assumed that the network device provides three MBS services: MBS service 1, MBS service 2, and MBS service 3. The network device can send the service identifiers and data status information of the three MBS services to the terminal device through MBS control information. In some embodiments, the service identifiers and data status information of the three MBS services can be implemented by means of MBS service fields or the aforementioned status bitmap or status recovery indices. After receiving the MBS control information, the terminal device can locate the service identifier and data status information of the MBS service that needs to be received. For example, in response to a determination that the terminal device only needs to receive MBS service 1, the terminal device can locate, in the MBS control information, the service identifier and data status information of MBS service 1. In response to a determination that the data status information of MBS service 1 indicates that the service data of MBS service 1 is in a transmission state, and the terminal device is in an inactive/idle state, the terminal device initiates an RRC connection and receives the service data of MBS service 1 after switching to the connected state. In response to a determination that the data status information of MBS service 1 indicates that transmission of the service data of MBS service 1 is stopped, the terminal device switches from a connected state to an inactive/idle state.

In the embodiment of the present disclosure, in response to a determination that the terminal device temporarily does not need to receive MBS service data, the terminal device can be released to the inactive/idle state. In response to a determination that there is MBS service data to be received, the terminal device switches to the connected state to continue to receive data. Moreover, in the embodiment of the present disclosure, the data status information of all the MBS services can be notified to the terminal device through a status bitmap, which saves bit resources in cases where there are a large quantity of MBS services.

In embodiment 2, a network device sends system information to a terminal device based on a Broadcast Control Channel (BCCH). System information is used to carry data status information of each MBS service. In some embodiments, the data status information of each MBS service in the system information may be implemented in the following manner. A first field is configured for the MBS service, and the data status information of the MBS service is indicated by the first field. In some embodiments, in the broadcast system information, the data status information of the MBS services may be indicated by a status bitmap. In some embodiments, in the broadcast system information, the data status information of the MBS services may be indicated by status recovery indices. Specifically, for the implementation manner of the data status information of the MBS services carried by the system information, reference can be made to Embodiment 1, and details are not described herein again.

In Embodiment 3, a network device sends DCI or a short message to a terminal device based on a Physical Downlink Control Channel (PDCCH). The DCI or short message is used to carry data status information of each MBS service. Considering limited bits of the DCI and short message, a status bitmap or status recovery indices are used in the DCI or short message to represent the data status information of the MBS services.

The data status information of the MBS services are represented by the status bitmap in the DCI or short message in the following manner. The status bitmap includes a plurality of bits, with each bit being mapped to one MBS service identifier. The value of the bit represents the data status information of the MBS service corresponding to the bit. For example, a bit value of 1 indicates that the service data of the corresponding MBS service is in a transmission state, while a bit value of 0 indicates that transmission of the service data of the corresponding MBS service is stopped. In some embodiments, the mapping relationship (first mapping relationship) between the MBS service identifiers and the bits of the status bitmap can be sent to the terminal device through MBS control information or system information. After receiving the status bitmap, the terminal device can locate a target bit corresponding to the target MBS service in the status bitmap according to the first mapping relationship, and determine the data status of the target MB S service according to the value of the target bit.

In some embodiments, in the DCI or short message, the data status information of the MBS services may be represented by status recovery indices, with each status recovery index representing data status information of one MBS service. In response to a determination that transmission of data of an MBS service is resumed, the network device can send the status recovery index corresponding to the MBS service to the terminal device. Further, the network device may send the mapping relationship (second mapping relationship) between MBS services and status recovery indices to the terminal device. Because bits of the DCI or short message are limited, the mapping relationship may be sent to the terminal device through MBS control information or system information. After receiving the status recovery index, the terminal device may determine, according to the second mapping relationship, that transmission of the data of the MBS service indicated by the status recovery index is resumed.

In this embodiment, transmitting the data status information of the MBS service through the DCI or short message can improve the transmission efficiency of the data status information and accelerate the response speed of the terminal device. Moreover, in this embodiment, by mapping the data status information of the MBS services to a status bitmap or status recovery indices, bit resources can be saved.

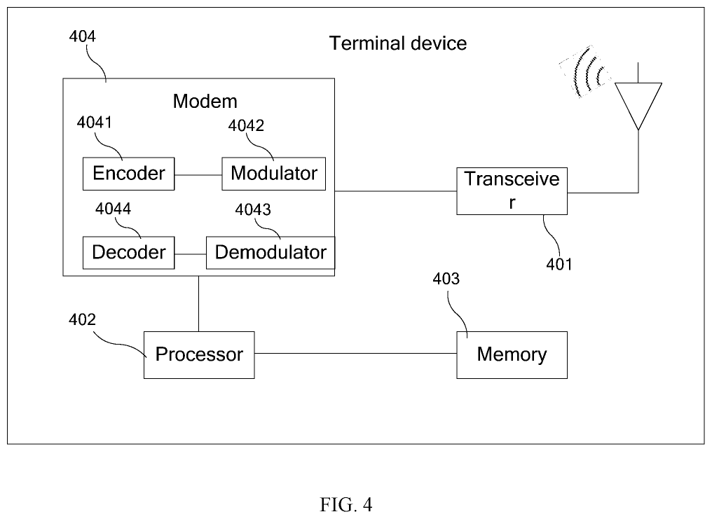

FIG. 3 is a flowchart of a method for sending MBS service data according to an embodiment of the present disclosure. The method is executed by the network device in the system shown in FIG. 1. As shown in FIG. 3, the method includes the following steps.

In S301, a network device sends first information to a terminal device, where the first information includes data status information of at least one MBS service. The first information is carried in one of or a combination of two or more of the following types of information: MBS control information, broadcast system information, DCI, and a short message.

In different carrying manners, the first information may be implemented as follows. The first information includes a service field of each MBS service, and the service field includes a first field indicating the data status information of the corresponding MBS service.

In some embodiments, the first information includes a status bitmap, where bits of the status bitmap indicate the data status information of the MBS services. In some embodiments, the network device further sends second information to the terminal device. The second information includes a first mapping relationship between the MBS services and the bits of the status bitmap.

In some embodiments, the first information includes status recovery indices. Each status recovery index corresponds to one MBS service, and indicates that service data of the corresponding MBS service is changed to a transmission state. In some embodiments, the network device further sends second information to the terminal device. The second information includes a second mapping relationship between the MBS services and the status recovery indices.

In S302, in response to determining, by the network device, that some or all MBS services of the at least one MBS service are in a transmission state, the network device sends service data of the some or all MBS services to the terminal device.

The second information is carried in one of or a combination of two or more of the following types of information: MBS control information, broadcast system information, DCI, and a short message. The first information and the second information may be carried in the same information or carried in different information.

The first mapping relationship is represented in an explicit manner. For example, the second information includes a correspondence between the MBS services and the bits of the status bitmap. Or the first mapping relationship is represented in an implicit manner. For example, the second information includes an MBS service list, and positions of the MBS services in the MBS service list correspond to the bits of the status bitmap.

The second mapping relationship is represented in an explicit manner. For example, the second information includes a correspondence between the MBS services and the status recovery indices. Or the second mapping relationship is represented in an implicit manner. For example, the second information includes an MBS service list, and positions of the MBS services in the MBS service list correspond to the status recovery indices.

In the embodiment of the present disclosure, for the manner in which the network device sends the data status information of the MBS services, reference can be made to the related description of the embodiment shown in FIG. 2, and details are not described herein again.

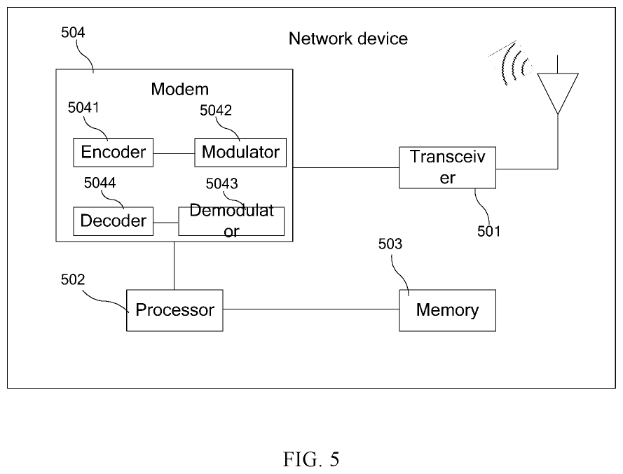

FIG. 4 is a schematic structural diagram of a terminal device according to an embodiment of the present disclosure. FIG. 4 shows a simplified schematic diagram of a possible design structure of the terminal device involved in the foregoing method embodiment. The terminal device includes a transceiver 401, a processor 402, a memory 403, and a modem 404. The transceiver 401, the processor 402, the memory 403, and the modem 404 are connected via a bus.

The transceiver 401 regulates an output sampling and generates an uplink signal. For example, the transceiver 401 performs analog conversion, filtering, amplification, and up-conversion. The uplink signal is transmitted to the network device described in the foregoing embodiment through an antenna. In the downlink, an antenna receives the downlink signal from the network device in the foregoing embodiment. The transceiver 401 regulates the signal received from the antenna. For example, the transceiver 401 performs filtering, amplification, down-conversion, and digitization. The transceiver 401 provides an input sampling. For example, an encoder 4041 in the modem 404 receives service data and a signaling message that are to be sent in the uplink, and processes (e.g., formatting, encoding, and interleaving) the service data and the signaling message. A modulator 4042 further processes the encoded service data and signaling message (e.g., symbol mapping and modulation) and provides the output sampling mentioned above. A demodulator 4043 processes the input sampling (e.g., demodulation) and provides a symbol estimate. A decoder 4044 processes the symbol estimate (e.g., deinterleaving and decoding) and provides the decoded data and signaling message to be sent to the terminal device. The encoder 4041, the modulator 4042, the demodulator 4043, and the decoder 4044 can be implemented by a synthesized modem 404. These units perform processing according to the wireless access technology used in the wireless access network (e.g., LTE, 5G, and other evolving system access technologies). In the embodiment shown in FIG. 4, the transceiver 401 includes a transmitter and a receiver that are integrated with each other. However, in other embodiments, the transmitter and the receiver can also be separate from each other.

The processor 402 performs control management on the terminal device, and is configured to perform the steps of processing conducted by the terminal device in the foregoing method embodiment. For example, the processor is configured to control the terminal device to perform upstream transmission and/or other processes related to the technology described in the present disclosure. As an example, the processor 402 is configured to support the terminal device to perform processes related to the terminal device in FIG. 2 and FIG. 3. For example, the transceiver 401 is configured to control/receive (through an antenna) a signal in upstream transmission. In different embodiments, the processor 402 may include one or more processors, such as one or more CPUs. The processor 402 may be integrated into a chip or may be a chip.

The memory 403 is configured to store relevant instructions and data, as well as program code and data of the terminal. In different embodiments, the memory 403 includes, but is not limited to, a Random Access Memory (RAM), a Read-Only Memory (ROM), an Erasable Programmable Read-Only Memory (EPROM), a non-transitory computer readable storage medium, or a Compact Disc Read-Only Memory (CDROM). In this embodiment, the memory 403 is independent of the processor 402. In other embodiments, the memory 403 may be integrated into the processor 402.

It should be understood that FIG. 4 only illustrates a simplified design of the terminal device. In different embodiments, the terminal device can include any number of transmitters, receivers, processors, memories, etc., and all network devices capable of implementing the terminal device of the present disclosure are within the protection scope of the present disclosure.

FIG. 5 is a schematic structural diagram of a network device according to an embodiment of the present disclosure. FIG. 5 shows a simplified schematic diagram of a possible design structure of the network device involved in the foregoing method embodiment. The network device includes a transceiver 501, a processor 502, a memory 503, and a modem 504. The transceiver 501, the processor 502, the memory 503, and the modem 504 are connected via a bus.

The transceiver 501 regulates (e.g., analog conversion, filtering, amplification, and up-conversion) an output sampling and generates a downlink signal. The downlink signal is transmitted to the terminal device described in the foregoing embodiment through an antenna. In the uplink, an antenna receives the uplink signal from the terminal device in the foregoing embodiment. The transceiver 501 regulates (e.g., filtering, amplification, down-conversion, and digitization) the signal received from the antenna and provides an input sample. For example, an encoder 5041 in the modem 504 receives service data and a signaling message that are to be sent in the downlink, and processes (e.g., formatting, encoding, and interleaving) the service data and the signaling message. A modulator 5042 further processes (e.g., symbol mapping and modulation) the encoded service data and signaling message and provides the output sample mentioned above. A demodulator 5043 processes (e.g., demodulation) the input sampling and provides a symbol estimate. A decoder 5044 processes (e.g., deinterleaving and decoding) the symbol estimate and provides the decoded data and signaling message to be sent to the network device. The encoder 5041, the modulator 5042, the demodulator 5043, and the decoder 5044 can be implemented by a synthesized modem 504. These units perform processing according to the wireless access technology used in the wireless access network (e.g., LTE, 5G, and other evolving system access technologies). In the embodiment shown in FIG. 5, the transceiver 501 includes a transmitter and a receiver that are integrated with each other. However, in other embodiments, the transmitter and the receiver can also be separate from each other.

The processor 502 performs control management on the network device, and is configured to perform the steps of processing conducted by the network device in the foregoing method embodiment. For example, the processor is configured to control the network device to perform upstream transmission and/or other processes related to the technology described in the present disclosure. As an example, the processor 502 is configured to support the network device to perform processes related to the network device in FIG. 2 and FIG. 3. For example, the transceiver 501 is configured to control/receive (through an antenna) a signal in upstream transmission. In different embodiments, the processor 502 may include one or more processors, such as one or more CPUs. The processor 502 may be integrated into a chip or may be a chip.

The memory 503 is configured to store relevant instructions and data, as well as program code and data of the terminal. In different embodiments, the memory 503 includes, but is not limited to, a Random Access Memory (RAM), a Read-Only Memory (ROM), an Erasable Programmable Read-Only Memory (EPROM), a non-transitory computer readable storage medium, or a Compact Disc Read-Only Memory (CDROM). In this embodiment, the memory 503 is independent of the processor 502. In other embodiments, the memory 503 may be integrated into the processor 502.

It should be understood that FIG. 5 only illustrates a simplified design of the network device. In different embodiments, the network device can include any number of transmitters, receivers, processors, memories, etc., and all network devices capable of implementing the network device of the present disclosure are within the protection scope of the present disclosure.

Corresponding to the above device embodiments, the present disclosure further provides a communication system that includes the terminal device shown in FIG. 4 and the network device shown in FIG. 5.

Furthermore, an embodiment of the present disclosure further provides a communication chip. The communication chip may be a chip for implementing the structure of the terminal device. In some embodiments, the communication chip includes: at least one processor configured to execute a computer program instruction stored in a memory. When the computer program instruction is executed by the at least one processor, the communication chip is caused to perform the method executed by the terminal device described in the foregoing embodiment.

In some embodiments, an embodiment of the present disclosure further provides a communication chip that may be a chip for implementing the structure of the network device. In some embodiments, the communication chip includes: at least one processor configured to execute a computer program instruction stored in a memory. When the computer program instruction is executed by the at least one processor, the communication chip is caused to perform the method executed by the network device described in the foregoing embodiment.

Some embodiments of the present disclosure further provide a non-transitory computer storage medium. The computer storage medium stores a program. When the program is executed, some or all of the steps in the embodiments provided by the present disclosure are executed. The storage medium may be a magnetic disk, an optical disc, a read-only memory (ROM), a random access memory (RAM), or the like.

In some embodiments, the present disclosure further provides a computer program product. The computer program product contains executable instructions. When executed on a computer, the executable instructions cause the computer to execute some or all of the steps in the foregoing method embodiment.

In the embodiments of the present disclosure, the term “at least one” refers to one or more, and the term “a plurality of” refers to two or more. The term “and/or” describes associations between associated objects, and it indicates three types of relationships. For example, “A and/or B” may indicate that A exists alone, A and B coexist, or B exists alone. “A” and “B” each may be singular or plural. The character “/” usually indicates an “or” relationship between associated objects. The term “at least one of the followings” or a similar expression refers to any combination of these items, including any combination of single items or plural items. For example, “at least one of a, b, and c” can indicate: a, b, c, a-b, a-c, b-c, or a-b-c, where a, b, and c may each be a single or plural item.

Those of ordinary skill in the art may be aware that units and algorithm steps described in the embodiments of the present disclosure can be implemented by electronic hardware or a combination of computer software and electronic hardware. Whether these functions are implemented by hardware or software depends on specific applications of the technical solutions and design constraints. A person skilled in the art may use different methods to implement the described functions for each specific application, but such implementation should not be considered to be beyond the scope of the present disclosure.

A person skilled in the art can clearly understand that for convenience and brevity of description, reference may be made to corresponding processes in the foregoing method embodiments for specific working processes of the foregoing systems, apparatuses, and units. Details are not described herein again.

In the embodiments provided by the present disclosure, if implemented in a form of a software functional unit and sold or used as a stand-alone product, the function may be stored in a computer-readable storage medium. Based on such understanding, the technical solutions of the present disclosure essentially or the part contributing to the prior art may be implemented in a form of a software product. The computer software product may be stored in a storage medium, and includes several instructions for enabling a computer device (which may be a personal computer, a server, a network device, or the like) to perform all or some steps of the methods described in the embodiments of the present disclosure. The foregoing storage medium includes: any medium that can store program code, such as a USB flash disk, a removable hard disk, a read-only memory (ROM), a random access memory (RAM), a magnetic disk, or an optical disc.

The foregoing merely describes specific implementations of the present disclosure. Any person skilled in the art can easily conceive modifications or replacements within the technical scope of the present disclosure, and these modifications or replacements shall fall within the protection scope of the present disclosure. The protection scope of the present disclosure shall be subject to the protection scope of the claims.

What is claimed is:

1. A method for receiving Multi-cast Broadcast Service (MBS) service data, comprising:
receiving first information sent by a network device, wherein the first information comprises data status information of at least one MBS service; and
determining whether to receive service data of the at least one MBS service according to the data status information of the at least one MBS service.

2. The method according to claim 1, wherein said determining whether to receive the service data of the at least one MBS service according to the data status information of the at least one MBS service comprises:
obtaining data status information of a target MBS service from the data status information of the at least one MBS service; and
receiving the service data of the target MBS service in response to a determination that the data status information of the target MBS service indicates that the service data of the target MBS service is in a transmission state; and not receiving the service data of the target MBS service in response to a determination that the data status information of the target MBS service indicates that the service data of the target MBS service is not in the transmission state.

3. The method according to claim 1, wherein the first information is carried in one of or a combination of two or more of the following types of information:
MBS control information;
system information;
Downlink Control Information (DCI); and
a short message.

4. The method according to claim 1, wherein the first information comprises a service field of each of the at least one MBS service, and each service field comprises a first field indicating the data status information of the corresponding MBS service.

5. The method according to claim 1, wherein the first information comprises a status bitmap, and at least one bit of the status bitmap indicates the data status information of the at least one MBS service.

6. The method according to claim 5, further comprising: receiving second information sent by the network device, wherein the second information comprises a first mapping relationship between the at least one MBS service and the at least one bit of the status bitmap.

7. The method according to claim 6, wherein the second information comprises a correspondence between the at least one MBS service and the at least one bit of the status bitmap.

8. The method according to claim 6, wherein the second information comprises an MBS service list, and a position of the at least one MBS service in the MBS service list corresponds to the at least one bit of the status bitmap.

9. The method according to claim 1, wherein the first information comprises at least one status recovery index, wherein the at least one status recovery index corresponds to the at least one MBS service, and each status recovery index indicates that the service data of the corresponding MBS service is switched to a transmission state.

10. The method according to claim 9, further comprising: receiving second information sent by the network device, wherein the second information comprises a second mapping relationship between the at least one MBS service and the at least one status recovery index.

11. The method according to claim 10, wherein the second information comprises a correspondence between the at least one MBS service and the at least one status recovery index.

12. The method according to claim 10, wherein the second information comprises an MBS service list, and a position of the at least one MBS service in the MBS service list corresponds to the at least one status recovery index.

13. The method according to claim 6, wherein the second information is carried in one of or a combination of two or more of the following types of information:
MBS control information;
system information;
DCI; and
a short message.

14. The method according to claim 2, wherein said receiving the service data of the target MBS service in response to a determination that the data status information of the target MBS service indicates that the service data of the target MBS service is in the transmission state comprises:
switching a Radio Resource Control (RRC) connection from an idle/inactive state to a connected state, and then receiving the service data of the target MBS service.

15. The method according to claim 2, wherein said not receiving the service data of the target MBS service in response to a determination that the data status information of the target MBS service indicates that the service data of the target MBS service is not in the transmission state comprises:
releasing a RRC connection from a connected state to an idle/inactive state in response to determining, according to the data status information of the target MBS service, that transmission of the service data of the target MBS service is terminated.

16. A terminal device, comprising:
at least one processor; and
a memory configured to store instructions executable by the at least one processor,
wherein the instructions cause the at least one processor to perform a method for receiving MBS service data, wherein the method comprises:
receiving first information sent by a network device, wherein the first information comprises data status information of at least one MBS service; and
determining whether to receive service data of the at least one MBS service according to the data status information of the at least one MBS service.

17. The terminal device according to claim 16, wherein the first information is carried in one of or a combination of two or more of the following types of information:
MBS control information;
system information;
DCI; and
a short message.

18. A communication chip, comprising: at least one processor configured to execute computer program instructions stored in a memory, wherein when the computer program instructions are executed by the at least one processor, the communication chip is caused to perform a method for receiving MBS service data, wherein the method comprises:
receiving first information sent by a network device, wherein the first information comprises data status information of at least one MBS service; and
determining whether to receive service data of the at least one MBS service according to the data status information of the at least one MBS service.

19. The communication chip according to claim 18, wherein the first information is carried in one of or a combination of two or more of the following types of information:
MBS control information;
system information;
DCI; and
a short message.

20. The communication chip according to claim 18, wherein the first information comprises a service field of each of the at least one MBS service, and each service field comprises a first field indicating the data status information of the corresponding MBS service, or wherein the first information comprises a status bitmap, and at least one bit of the status bitmap indicates the data status information of the at least one MBS service.
